(19) United States
(12) Patent Application Publication
(10) Pub. No.: US 2019/0016636 A1
(43) Pub. Date: Jan. 17, 2019

(54) ONE-STEP CLIMATE STABLIZING ACCELERATOR MANUFACTURING AND GYPSUM-FIBER COMPOSITE BOARD MANUFACTURED THEREFROM

(71) Applicant: UNITED STATES GYPSUM COMPANY, Chicago, IL (US)

(72) Inventors: Wei XU, Vernon Hills, IL (US); Marsha S. SKINNER, Port Clinton, OH (US)

(73) Assignee: UNITED STATES GYPSUM COMPANY, Chicago, IL (US)

(21) Appl. No.: 15/649,207

(22) Filed: Jul. 13, 2017

(51) Int. Cl. C04B 28/14; D21J 1/16

(52) U.S. Cl. CPC C04B 28/141; C04B 2111/0062; D21J 1/16

(57) ABSTRACT

A method can include: hot milling a mixture comprising calcium sulfate dihydrate and about 5% to about 25% sucrose by weight of the calcium sulfate dihydrate at a temperature of about 150° F. (66° C.) to about 250° F. (121° C.) to produce a climate stabilizing accelerator (CSA). The CSA produced from this method is dispersed in water and optionally aged for at least 1 minute before use in forming gypsum-fiber composite boards.

### FIELD OF THE INVENTION

The present invention relates in some aspects to methods of producing climate stabilizing accelerator (CSA) in a one-step manufacturing process, which can be integrated into the manufacturing of gypsum-fiber composite board.

### BACKGROUND OF ART

Certain properties of gypsum (calcium sulfate dihydrate) make it very popular for use in making industrial and building products; especially gypsum wallboard. It is a plentiful and generally inexpensive raw material which, through a process of dehydration and rehydration, can be cast, molded or otherwise formed into useful shapes. It is also noncombustible and relatively dimensionally stable when exposed to moisture. However, because it is a brittle, crystalline material which has relatively low tensile and flexural strength, its uses are typically limited to non-structural, non-load bearing and non-impact absorbing applications.

Gypsum wallboard; i.e. also known as plasterboard or drywall, consists of a rehydrated gypsum core sandwiched between multi-ply paper cover sheets, and is used largely for interior wall and ceiling applications. Because of the brittleness and low nail and screw holding properties of its gypsum core, conventional drywall by itself cannot support heavy appended loads or absorb significant impact.

Accordingly, means to improve the tensile, flexural, nail and screw holding strength and impact resistance of gypsum plasters and building products have long been, and still are, earnestly sought.

Another readily available and affordable material, which is also widely used in building products, is lignocellulosic material particularly in the form of wood and paper fibers. For example, in addition to lumber, particleboard, fiberboard, waferboard, plywood and “hard” board (high density fiberboard) are some of the forms of processed lignocellulosic material products used in the building industry. Such materials have better tensile and flexural strength than gypsum. However, they are also generally higher in cost, have poor fire resistance and are frequently susceptible to swelling or warping when exposed to moisture Therefore, affordable means to improve upon these use limiting properties of building products made from cellulosic material are also desired.

Previous attempts to combine the favorable properties of gypsum and cellulosic fibers, particularly wood fibers, have had very limited success. Attempts to add cellulosic fibers, (or other fibers for that matter), to gypsum plaster and/or plasterboard core have generally produced little or no strength enhancement because of the heretofore inability to achieve any significant bond between the fibers and the gypsum. U.S. Pat. Nos. 4,328,178; 4,239,716; 4,392,896 and 4,645,548 disclose recent examples where wood fibers or other natural fibers were mixed into a stucco (calcium sulfate hemihydrate) slurry to serve as reinforcers for a rehydrated gypsum board or the like.

U.S. Pat. No. 4,734,163, teaches a process in which raw or uncalcined gypsum is finely ground and wet mixed with 5-10% paper pulp. The mash is partially dewatered, formed into a cake and further dewatered by pressure rolls until the water/solids ratio is less than 0.4. The cake is cut into green boards, which, after being trimmed and cut, are stacked between double steel plates and put into an autoclave. The temperature in the autoclave is raised to about 140° C. to convert the gypsum to calcium sulfate alpha hemihydrate. During the subsequent incremental cooling of the vessel boards, the hemihydrate rehydrates back to dihydrate (gypsum) and gives the board integrity. The boards are then dried and finished as necessary.

U.S. Pat. No. 5,320,677 to Baig describes a composite product and a process for producing the product in which a dilute slurry of gypsum particles and wood fibers are heated under pressure to convert the gypsum to calcium sulfate alpha hemihydrate. The wood fibers have pores or voids on the surface and the alpha hemihydrate crystals form within, on and around the voids and pores of the wood fibers. The heated slurry is then dewatered to form a filter cake, preferably using equipment similar to paper making equipment, and before the slurry cools enough to rehydrate the hemihydrate to gypsum, the filter cake is pressed into a board of the desired configuration. The pressed filter cake is cooled and the hemihydrate rehydrates to gypsum to form a dimensionally stable, strong and useful building board. The board is thereafter trimmed and dried. The process described in U.S. Pat. No. 5,320,677 is distinguishable from the earlier processes in that the calcination of the gypsum takes place in the presence of the wood fibers, while the gypsum is in the form of a dilute slurry, so that the slurry wets out the wood fibers, carrying dissolved gypsum into the voids of the fibers, and the calcining forms acicular calcium sulfate alpha-hemihydrate crystals in situ in and about the voids.

Conversion of the gypsum to calcium sulfate hemihydrate can be hastened by using an accelerator. For example, U.S. Pat. No. 7,413,603 to Miller et al. discloses fiber board production using alpha-calcined calcium sulfate hemihydrate using a heat resistant accelerator (HRA), which is calcium sulfate dihydrate freshly ground with sugar at a ratio of about 5 to about 25 pounds of sugar per 100 pounds of calcium sulfate dihydrate as described in U.S. Pat. No. 2,078,199 to King.

U.S. Pat. No. 3,573,947 to Lisel et al. discloses a climate stabilized accelerator (CSA) produced by calcining HRA. The calcining is performed in a separate step from HRA production. The HRA is placed in shallow beds, approximately on inch deep, and heated to about 150° F. (66° C.) to about 250° F. (121° C.) for over 90 hours in some instances. The use of deeper beds causes water condensation on the HRA particles, which negates the calcining process. Because of the two-step manufacturing process of CSA (i.e., make HRA in a ball mill then calcine the HRA in separate trays), CSA is more expensive than HRA and LPA. Consequently, CSA is not typically used in the gypsum-fiber composite board manufacturing processes.

### SUMMARY OF THE INVENTION

The present invention relates in some aspects to methods of producing climate stabilizing accelerator (CSA) in a one-step manufacturing process, which can be integrated into the manufacturing of gypsum-fiber composite board.

One aspect of the invention is a method comprising: hot milling a mixture comprising calcium sulfate dihydrate and about 5% to about 25% sucrose by weight of the calcium sulfate dihydrate at a temperature of about 150° F. (66° C.) to about 250° F. (121° C.) to produce a CSA. The CSA produced from this method is dispersed in water and optionally aged for at least 1 minute before use in forming gypsum-fiber composite boards.

The climate stabilizing accelerator (CSA) from the above noted one-step manufacturing process is preferably used in a method comprising: mixing uncalcined gypsum, host particles, and water to form an aqueous slurry; calcining the uncalcined gypsum by exposing the aqueous slurry to steam in a pressure vessel, thereby producing an calcined gypsum slurry, and discharging the calcined gypsum slurry from the pressure vessel; dispersing the CSA in water, thereby producing a CSA dispersion; adding the CSA dispersion to the discharged calcined slurry (typically at a headbox), thereby producing a product slurry; forming a filter cake from the product slurry; and forming a gypsum-fiber composite board from the filter cake. The CSA dispersion is optionally aged for at least 1 minute before use in forming gypsum-fiber composite board.

One aspect of the invention is a method comprising: mixing uncalcined gypsum, host particles, and water to form an aqueous slurry; calcining the uncalcined gypsum by exposing the aqueous slurry to steam in a pressure vessel, thereby producing an calcined gypsum slurry, and discharging the calcined gypsum slurry from the pressure vessel; dispersing a climate stabilizing accelerator (CSA) from any source in water, thereby producing a CSA dispersion; adding the CSA dispersion to the discharged calcined slurry (typically at a headbox), thereby producing a product slurry; forming a filter cake from the product slurry; and forming a gypsum-fiber composite board from the filter cake. The CSA dispersion is optionally aged for at least 1 minute before use in forming gypsum-fiber composite board.

Advantages of the present invention may become apparent to those skilled in the art from a review of the following detailed description, taken in conjunction with the examples, and the appended claims. It should be noted, however, that while the invention is susceptible of examples in various forms, described hereinafter are specific examples of the invention with the understanding that the present disclosure is intended as illustrative, and is not intended to limit the invention to the specific examples described herein.

### BRIEF DESCRIPTION OF THE DRAWINGS

FIG. 1 illustrates a schematic diagram of an exemplary process 10 for producing gypsum-fiber composite boards according to one aspect of the invention.

### DETAILED DESCRIPTION OF THE INVENTION

All percentages and ratios used herein, unless otherwise specified, are by weight wt %) unless otherwise indicated.

The term “gypsum”, as used herein, means calcium sulfate in the stable dihydrate state; i.e., CaSO₄.2H₂O, and includes the naturally occurring mineral, the synthetically derived equivalents, and the dihydrate material formed by the hydration of calcium sulfate hemihydrate (stucco) or anhydrite. The term “calcium sulfate material”, as used herein, means calcium sulfate in any of its forms, namely calcium sulfate anhydrite, calcium sulfate hemihydrate, calcium sulfate dihydrate and mixtures thereof.

The term “calcined gypsum”, as used herein, means calcium sulfate in the hemihydrate state; i.e., CaSO₄.½H₂O.

The term “host particle” is meant to cover any macroscopic particle, such as a fiber, a chip, or a flake, of a substance other than gypsum. The particle, which is generally insoluble in the slurry liquid, should also have accessible voids therein; whether pits, cracks, fissures, hollow cores, or other surface imperfections, which are penetrable by the slurry menstruum and within which calcium sulfate crystals can form. It is also desirable that such voids are present over an appreciable portion of the particle; it being apparent that the more and better distributed the voids, the greater and more geometrically stable will be the physical bonding between the gypsum and host particle. The substance of the host particle should have desirable properties lacking in the gypsum, and, preferably, at least higher tensile and flexural strength. A lignocellulosic fiber, particularly a wood fiber, is an example of a host particle especially well-suited for the composite material and process of the invention. Therefore, without intending to limit the material and/or particles that qualify as a “host particle”, wood fiber(s) is often used hereafter for convenience in place of the broader term.

The term “gypsum/wood fiber”, which is sometimes abbreviated as “GWF”, as used herein, is meant to cover a mixture of a calcium sulfate material and host particles, e.g. wood fibers, which is used to produce boards wherein at least a portion of the calcium sulfate material is in the form of acicular calcium sulfate dihydrate crystals positioned in and about the voids of the host particles, wherein the dihydrate crystals are formed in situ by the hydration of acicular calcium sulfate hemihydrate crystals in and about the voids of said particles. The GWF boards are preferably produced by the process of U.S. Pat. No. 5,320,677, herein incorporated by reference.

The term “land plaster accelerator” (LPA), as used herein, means pure land plaster.

The term “heat resistant accelerator” (HRA), as used herein, means calcium sulfate dihydrate freshly ground with sugar at a ratio of about 5 to 25 pounds of sugar per 100 pounds of calcium sulfate dihydrate. It is further described in U.S. Pat. No. 2,078,199, herein incorporated by reference. HRA can be made from dry grinding land plaster (calcium sulfate dihydrate). Small amounts of additives (normally about 5 wt % by weight) such as sugar, dextrose, boric acid, and starch can be used to make this HRA.

The term “climatic stabilizing accelerator” (CSA), as used herein, means a calcined or partially calcined HRA.

One-Step CSA Manufacturing Process

One aspect of the present invention is a one-step CSA manufacturing process. An exemplary one-step CSA manufacturing process includes mixing calcium sulfate dihydrate with about 5% to about 25%, preferably about 5% to about 15%, sucrose by weight of calcium sulfate dihydrate and optionally inert materials like sand in a mill (e.g., a ball mill). The mill acts not only to mix the components but also to grind the components to a finer mesh size and intimately associate the sugar and the calcium sulfate dihydrate. Simultaneously while mixing the components in the mill, the temperature is increased to a sufficient degree to permit partial calcining of the of calcium sulfate dihydrate to achieve a combined water content of about 10 wt % to about 15 wt %, which is referred to herein as “hot milling.” The temperature during hot milling is about 150° F. (66° C.) to about 275° F. (135° C.), preferably 175° F. (79° C.) to 250° F. (121° C.) and can be achieved by the temperature increase caused during milling, by adding additional heat to the mill (e.g., using external heating elements), or a combination thereof. In contrast, the traditional two-step manufacturing process cools the ball mill in the first step to maintain a low temperature that does not or minimally reduces the water content of the components in the mill.

The amount of time the components are hot milled may be about 45 minutes to overnight or longer, preferably about 45 minutes to about 6 hours, preferably about 1 hour to about 2 hours.

In some instances, the particle size of the resultant CSA powder can be about 10 microns to about 50 microns, preferably about 10 microns to about 25 microns. In some instances, the surface area of the resultant CSA powder can be about 1 m²/g to about 10 m²/g, preferably about 4 m²/g to about 7 m²/g.

Using a one-step manufacturing process reduces CSA production costs, which allows for the improved line speeds described above to be realized with minimal to no increase in the cost of the accelerator as compared to currently used LPA and HRA.

Gypsum-Fiber Composite Board Manufacturing Process

One aspect of the invention is a method comprising: mixing uncalcined gypsum, host particles, and water to form an aqueous slurry; calcining the uncalcined gypsum by exposing the aqueous slurry to steam in a pressure vessel, thereby producing an calcined gypsum slurry, and discharging the calcined gypsum slurry from the pressure vessel; dispersing a climate stabilizing accelerator (CSA) from any source in water, thereby producing a CSA dispersion; adding the CSA dispersion to the discharged calcined slurry (typically at a headbox), thereby producing a product slurry; forming a filter cake from the product slurry; and forming a gypsum-fiber composite board from the filter cake. The CSA dispersion is optionally aged for at least 1 minute before use in forming gypsum-fiber composite board.

Preferably the CSA from the inventive one-step manufacturing process can be integrated into the gypsum-fiber composite board manufacturing line where the hot milled CSA is mixed with water to form a dispersion and added directly from the mill to a calcined gypsum slurry (described further below). The hot milled CSA can be dispersed in water or other suitable liquid carrier before addition to the calcined gypsum slurry being processed on the gypsum-fiber composite board manufacturing line. The hot milled CSA may be dispersed in water or other suitable liquid carrier and aged for at least one minute (e.g., about one minute or longer including overnight or longer, preferably about one minute to about 13 hours, more preferably about one minute to about 3 hours, most preferably about one minute to about 1 hour) before addition to the slurry being processed on the gypsum-fiber composite board manufacturing line. Advantageously, as illustrated in the example, aging the CSA in water does not adversely affect its efficacy as an accelerator.

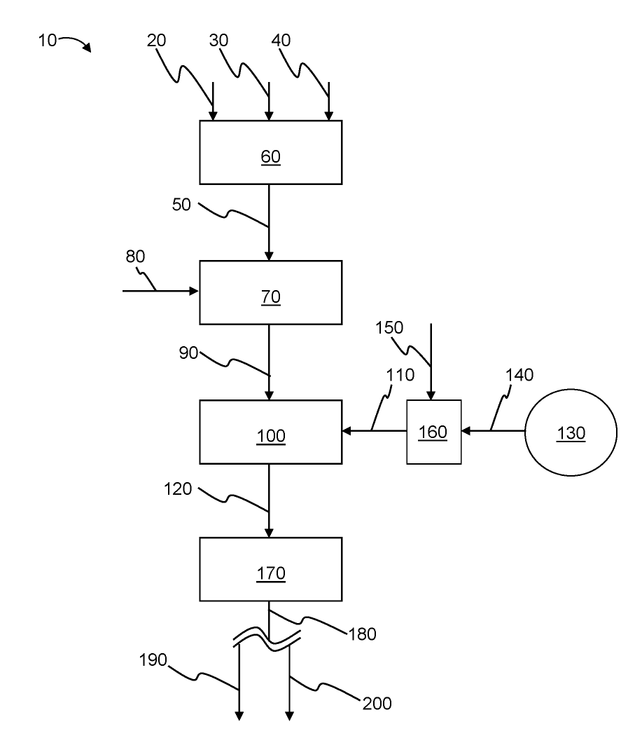

FIG. 1 illustrates a schematic diagram of an exemplary process 10 for producing gypsum-fiber composite boards according to one aspect of the invention. The described exemplary process 10 begins by mixing uncalcined gypsum 20 and host particles 30 (e.g. wood or paper fibers) with water 40 to form a dilute aqueous slurry 50 (also referred to herein as a feed slurry 50) in a mixer 60. The source of the gypsum 20 may be from raw ore or from the by-product of a flue-gas-desulphurization or phosphoric-acid process. The gypsum 20 should be of a relatively high purity, i.e., preferably at least about 92 wt % to 96 wt %, and finely ground, for example, to 92 wt % to 96 wt % of minus 100 mesh or smaller. Larger particles may lengthen the conversion time. The gypsum 20 can be introduced as an aqueous slurry.

The host particle 30 (also referred to herein as wood fibers 30) is preferably a cellulosic fiber which may come from waste paper, wood pulp, wood flakes, and/or another plant fiber source. Preferably the fiber is porous, hollow, split, and/or rough surfaced such that its physical geometry provides accessible interstices or voids which accommodate the penetration of dissolved calcium sulfate. In any event the source, for example, wood pulp, may also require prior processing to break up clumps, separate oversized and undersized material, and, in some cases, pre-extract strength retarding materials and/or contaminants that could adversely affect the calcination of the gypsum 20; such as hemi-celluloses, acetic acid, etc.

The gypsum 20 and wood fibers 30 are mixed with sufficient water 40 to make the feed slurry 50 having a solids content of about 5 wt % to about 30 wt % (i.e., water 40 at about 70 wt % to about 95 wt %), although the feed slurry 50 having a solids content at about 5 wt % to about 20 wt % is preferred. The solids in the feed slurry 50 should comprise from wood fibers 30 at about 0.5 wt % to about 30 wt % and preferably wood fibers 30 at about 3 wt % to about 20 wt %, the balance being mainly gypsum 20 (e.g, at least about 95 wt % of the balance being gypsum 20).

The feed slurry 50 is fed into a pressure vessel 70 (e.g., an autoclave) equipped with a continuous stirring or mixing device. Crystal modifiers, such as organic acids, can be added to the slurry at this point, if desired, to stimulate or retard crystallization or to lower the calcining temperature. Steam 80 is injected into the vessel 70 to bring the interior temperature of the vessel 70 up to between about 212° F. (100° C.) and about 350° F. (177° C.), and autogeneous pressure; the lower temperature being approximately the practical minimum at which the calcium sulfate dehydrate will calcine to the hemihydrate state within a reasonable time; and the higher temperature being about the maximum temperature for calcining hemihydrate without undue risk of causing some the calcium sulfate hemihydrate to convert to anhydrite. The vessel 70 temperature is preferably on the order of about 285° F. (140° C.) to 305° F. (152° C.).

When the feed slurry 50 is processed under these conditions for a sufficient period of time, for example on the order of 15 minutes, enough water will be driven out of the calcium sulfate dihydrate molecule to convert it to the hemihydrate molecule. The solution, aided by the continuous agitation to keep the particles in suspension, will wet out and penetrate the open voids in the host particles 30. As saturation of the solution is reached, the hemihydrate will nucleate and begin forming crystals in, on and around the voids and along the walls of the fibers of the host particles 30.

It is believed that during the autoclaving operation, the dissolved calcium sulfate penetrates into the voids in the wood fibers 30 and subsequently precipitates as acicular hemihydrate crystals within, on, and about the voids and surfaces of the wood-fibers.

After the conversion of the dihydrate to the hemihydrate (i.e., calcining of the gypsum) is complete, the pressure on the vessel 70 is reduced and the calcined gypsum slurry 90 is passed through a headbox 100 where a CSA dispersion 110 is added to produce a product slurry 120. The CSA dispersion 110 added to the calcined gypsum slurry 90 at the headbox 100 may be produced from a traditional two-step process or preferably the inventive one-step process described herein. For example, as illustrated in FIG. 1 the CSA dispersion 110 is from the one-step process where the components (e.g., HRA and sugar) are hot milled in a ball mill 130 for sufficient time to produce CSA 140 that is mixed with water or other suitable liquid aqueous carrier 150 in a vessel 160 to produce the CSA dispersion 110. The CSA can be aged in the vessel 160 for a desired amount of time until added to the headbox 100 including overnight, typically at least one minute, preferably about one minute to about 13 hours, more preferably about one minute to about 3 hours, most preferably about one minute to about 1 hour.

The headbox 100 distributes the product slurry 120 onto a dewatering conveyor 170 (e.g., a flat porous forming surface). While on the dewatering conveyor 170, as much as 90% of the water in the product slurry 120 is removed, leaving a filter cake 180 having approximately 35 wt % water by weight. At this stage the filter cake 180 consists of wood fibers interlocked with rehydratable calcium sulfate hemihydrate crystals and can still be broken up into individual composite fibers or nodules, shaped, cast, or compacted to a higher density. At this point, the filter cake 180 can be either preserved as a hemihydrate composite 190 (i.e., a composite of calcium sulfate hemihydrate and wood fibers) for future product formation or formed directly into a product composed of dihydrate composite 200 (i.e., a composite of calcium sulfate dihydrate and wood fibers), each of which is described in U.S. Pat. No. 5,320,677, herein incorporated by reference.

For example, if it is desired to preserve the a hemihydrate composite 190 in a rehydratable state for future use, it is necessary to dry it promptly, preferably at about 200° F. (93° C.), to remove the remaining free water before hydration starts to take place.

Alternatively, the dewatered filter cake can be directly formed into a desired product shape and then rehydrated to the dihydrate composite 200. To accomplish this, the temperature of the filter cake 180 is brought down to below about 120° F. (49° C.). Although, the extraction of the bulk of the water 40 in the dewatering step will contribute significantly to lowering the filter cake 180 temperature, additional external cooling may be required to reach the desired level within a reasonable time. Because of the interlocking of the acicular hemihydrate crystals with the wood-fibers, and the removal of most of the carrier liquid from the filter cake 180, migration of the calcium sulfate is averted, leaving a homogeneous composite.

Then, the filter cake 180 can be rehydrated. The rehydration effects a recrystallization of the hemihydrate to dihydrate in place within and about the voids and on and about the wood fibers, thereby preserving the homogeneity of the composite. The crystal growth also connects the calcium sulfate crystals on adjacent fibers to form an overall crystalline mass, enhanced in strength by the reinforcement of the wood fibers.

Before the hydration is complete, it is desirable to promptly dry the composite mass to remove the remaining free water. Otherwise the hygroscopic wood fibers tend to hold, or even absorb, uncombined water which will later evaporate. If the calcium sulfate coating is fully set before the extra water is driven off, the fibers may shrink and pull away from the gypsum when the uncombined water does evaporate. Therefore, for optimum results it is preferable to remove as much excess free water from the composite mass as possible before the temperature drops below the level at which hydration begins.

When finally set, the dihydrate composite 200 exhibits desired properties contributed by both of its two components. The wood fibers increase the strength, particularly flexural strength, of the gypsum matrix, while the gypsum acts as a coating and binder to protect the wood fiber, impart fire resistant and decrease expansion due to moisture.

The filter cake 180, the hemihydrate composite 190, and the dihydrate composite 200 may have a thickness of about ¼ in to about 1 in, and preferable about ¼ in to about ⅜ in. Typically, a line speed during gypsum-fiber composite board manufacturing for thicker boards (e.g., ½ in and greater) is limited by the speed of drying steps. However, for thinner boards, the hydration of the filter cake 150 limits the line speed. As illustrated in the examples below, implementing CSA in liquid form in the methods of the present invention decreases the hydration time, which could translate to 15-20% greater line speeds.

The compositions and processes of the present invention typically have an absence of additives referred to in US Patent Application Publication No. 2013/0216762 to Chan et al, for example those referred to in paragraph [0021] of US Patent Application Publication No. 2013/0216762 to Chan et al, as high efficiency heat sink additives (“HEHS additives”). HEHS Additives have a heat sink capacity that exceeds the heat sink capacity of comparable amounts of gypsum dihydrate in the temperature range causing the dehydration and release of water vapor from the gypsum dihydrate component of the gypsum product. Such additives can be selected from compositions, such as aluminum trihydrate or other metal hydroxides, such as magnesium hydroxide, that decompose, releasing water vapor in the same or similar temperature ranges as does gypsum dihydrate. There is generally an absence of HEHS additives (or combinations of HEHS additives) with increased heat sink efficiency relative to comparable amounts of gypsum dihydrate as well as HEHS additives which provide a sufficiently-increased heat sink efficiency relative to gypsum dihydrate to offset any increase in weight or other undesired properties of the HEHS additives when used in a gypsum product intended for fire rated or other high temperature applications

The following examples are presented to further illustrate some preferred examples of the invention and to compare them with conventional methods and compositions outside the scope of the invention. The invention is not limited by the following examples but rather is defined by the claims appended hereto.

### EXAMPLES

TABLE 1 provides the water content and surface area characteristics of the accelerators used in the below COMPARATIVE EXAMPLES. The stucco (calcium sulfate hemihydrate) used in the following experiments is considered to be pseudo alpha and has a combined water content of 20.1% and a surface area of 0.624 m²/g.

TABLE 1

| Accelerator | Combined Water Content (%) | Surface Area (m²/g) |
|---|---|---|
| LPA | 19.7 | 5.771 |
| HRA | 19.8 | 5.572 |
| CSA | 12.6 | 5.791 |

### Comparative Example 1

The efficacy of the dry form of the three accelerators was tested. In amounts provided in TABLE 2, each accelerator was mixed with 200 g stucco. 200 g of water was added to the stucco/accelerator mixture and then mixed in a kitchen blender for 7 seconds to produce a slurry, which was poured into a paper cup and transferred to a temperature rise system (TRS) unit for analysis.

TABLE 2 lists the times to reach 50% setting and 98% setting (measured by the TRS unit) as a function of the accelerator and the accelerator amount.

TABLE 2

| | HRA | | LPA | | CSA | |
|---|---|---|---|---|---|---|
| | 50% | 98% | 50% | 98% | 50% | 98% |
| Accelerator | Setting | Setting | Setting | Setting | Setting | Setting |
| Amount | Time | Time | Time | Time | Time | Time |
| (wt %) | (min) | (min) | (min) | (min) | (min) | (min) |
| 0 | 22.17 | 30 | 22.17 | 30 | 22.17 | 30 |
| 0.125 | 8.83 | 15.17 | 14 | 20.5 | 12.08 | 18.67 |
| 0.25 | 7.25 | 13.33 | 11.3 | 18.08 | 10.25 | 16.58 |
| 0.5 | 5.75 | 11.75 | 9.58 | 15.58 | 8.5 | 14.67 |
| 0.75 | 5.25 | 11.17 | 8.5 | 14.5 | 7.75 | 13.83 |
| 1.0 | 4.83 | 10.58 | 7.67 | 13.67 | 6.92 | 13.08 |
| 1.25 | 4.17 | 10.17 | 7.25 | 13.17 | 6.25 | 12.33 |
| 1.5 | 4 | 10 | 6.83 | 12.67 | 6 | 12.15 |
| 1.75 | 4.92 | 9.83 | 6.25 | 12.08 | 5.83 | 12 |
| 2.0 | 3.67 | 9.5 | 6.08 | 11.83 | 5.5 | 11.5 |

The time to 50% setting and time to 98% setting were analyzed because each corresponds to a manipulation point in the production line for gypsum-fiber composite board. At about 50% setting, the filter cake has sufficient strength to be pressed to and retain its final thickness. At about 98% setting, hydration is essentially complete and the gypsum-fiber composite has been formed and can be cut into boards for complete drying in a kiln.

In the present example, using HRA in solid form provides faster setting than LPA and CSA in solid form, which have provide comparable setting times.

### Example 2

The efficacy of the liquid form of the three accelerators was tested. 1 wt % accelerator in water was prepared and allowed to age for different times reported in TABLE 3. To test the potency of the accelerator after aging 50% setting and 98% setting (measured by the TRS unit) were measured.

The preparation of the samples included dissolving the accelerator at 1 wt % in 200 g of water accompanied by periodic stirring. After the aging time listed in TABLE 3, each liquid accelerator was mixed with 200 g stucco and then mixed in a kitchen blender for 7 seconds to produce a slurry, which was poured into a paper cup and transferred to a temperature rise system (TRS) unit for analysis.

TABLE 3

| | HRA | | LPA | | CSA | |
|---|---|---|---|---|---|---|
| Accelerator | 50% | 98% | 50% | 98% | 50% | 98% |
| Aging Time | Setting | Setting | Setting | Setting | Setting | Setting |
| in Water | Time | Time | Time | Time | Time | Time |
| (min) | (min) | (min) | (min) | (min) | (min) | (min) |
| 0 | 4.83 | 10.58 | 7.67 | 13.67 | 6.92 | 13.08 |
| 0.5 | 8.67 | 14.75 | 11.83 | 18.08 | 6.42 | 13.17 |
| 1 | 9.17 | 15.17 | 11.67 | 18 | 6.83 | 13.08 |
| 10 | 9.58 | 15.5 | 11.5 | 17.83 | 6.67 | 12.92 |
| 30 | 9.67 | 15.75 | 11.3 | 17.67 | 6.25 | 12.25 |

In typical manufacturing, the accelerator ages in the water for about 10 minutes before being added to a slurry. This example illustrates that CSA in water does not loose potency over time but rather appears to increase in potency when aged in water. In contrast, the setting times for both HRA and LPA significantly increase with just 30 seconds in water.

What is claimed is:

1. A method comprising:
hot milling a mixture comprising calcium sulfate dihydrate and about 5% to about 25% sucrose by weight of the calcium sulfate dihydrate at a temperature of about 150° F. (66° C.) to about 250° F. (121° C.) to produce a climate stabilized accelerator (CSA).

2. The method of claim 1, wherein the hot milling occurs in a ball mill.

3. The method of claim 1, wherein the mixture further comprises sand.

4. The method of claim 1, wherein the hot milling occurs for about 45 minutes to about 6 hours.

5. The method of claim 1, wherein the hot milling occurs for about 45 minutes to about 2 hours.

6. The method of claim 1, further comprising: forming a gypsum-fiber composite board with the CSA.

7. The method of claim 1, further comprising:
mixing uncalcined gypsum, host particles, and water to form an aqueous slurry;
calcining the uncalcined gypsum by exposing the aqueous slurry to steam in a pressure vessel, thereby producing an calcined gypsum slurry, and discharging the calcined gypsum slurry from the pressure vessel;
dispersing the CSA in water, thereby producing a CSA dispersion;
adding the CSA dispersion to the discharged calcined gypsum slurry, thereby producing a product slurry;
forming a filter cake from the product slurry; and
forming a gypsum-fiber composite board from the filter cake.

8. The method of claim 7, further comprising
aging the CSA dispersion for about 1 minute to about 3 hours before addition to the calcined slurry.

9. The method of claim 7, further comprising
aging the CSA dispersion for about 1 minute to about 1 hour before addition to the calcined slurry.

10. The method of claim 7, wherein the gypsum-fiber composite board is less than ½ inch thick.

11. The method of claim 7, wherein the host particles comprise wood fibers.

12. The method of claim 7, wherein the CSA dispersion is added to the calcined gypsum slurry at a headbox.

13. A method comprising:
mixing uncalcined gypsum, host particles, and water to form an aqueous slurry;
calcining the uncalcined gypsum by exposing the aqueous slurry to steam in a pressure vessel, thereby producing an calcined gypsum slurry, and discharging the calcined gypsum slurry from the pressure vessel;
dispersing a climate stabilized accelerator (CSA) in water, thereby producing a CSA dispersion;
adding the CSA dispersion to the calcined gypsum slurry at a headbox, thereby producing a product slurry;
forming a filter cake from the product slurry; and
forming a gypsum-fiber composite board from the filter cake.

14. The method of claim 13, further comprising
aging the CSA dispersion for about 1 minute to about 3 hours before addition to the calcined slurry.

15. The method of claim 13, further comprising
aging the CSA dispersion for about 1 minute to about 1 hour before addition to the calcined slurry.

16. The method of claim 13, wherein the CSA dispersion is added to the calcined gypsum slurry at a headbox.

17. The method of claim 13, wherein the product slurry has an absence of high efficiency heat sink additives.
